(19) United States
(12) Patent Application Publication
(10) Pub. No.: US 2005/0213423 A1
(43) Pub. Date: Sep. 29, 2005

(54) Apparatus for manufacturing thermosetting powder coating compositions with dynamic control including low pressure injection system

(76) Inventors: Joseph M. Ferencz, Litchfield, OH (US); Charles A. Ammons, Brook Park, OH (US); Gregory J. Denk, Olmsted Twp., OH (US)

Correspondence Address: PPG INDUSTRIES, INC.;Intellectual Property Department, One PPG Place, Pittsburgh, PA, 15272, US

(21) Appl. No.: 10/809,639

(22) Filed: Mar. 25, 2004

(51) Int. Cl. B29B 7/24; B29B 7/60; B29C 47/10

(52) U.S. Cl. 366/76.2

(57) ABSTRACT

A thermosetting powder coating composition extruder system including an extruder body and an injection system is disclosed. The extruder body includes segments surrounding one or more rotating screws. A first segment's main inlet receives material, such as from a pre-mix hopper, and a final segment's outlet discharges extrudate. A low pressure injector injects additives, particularly those that are hard to incorporate, into one or more segments at one or more injection positions at the main inlet or between the main inlet and the outlet. The injector includes a source of pressurization coupled to a pressure vessel, a pressure regulator maintaining the pressure at or below a given level, a flow regulator, and an injection port. A sensor adjacent the outlet monitors the physical characteristics of the extrudate and is coupled to a controller of the low pressure injector for dynamic control thereof.

### FIELD OF THE INVENTION

The present invention relates to the field of manufacturing powder coating compositions, and in particular to an extrusion system for forming thermosetting powder coating compositions with dynamic control having a low pressure injection system.

### BACKGROUND OF THE INVENTION

Powder coating compositions are well known in the industry and have been prepared by various methods. The use of powder coatings has grown dramatically primarily due to their environmental advantages over liquid coatings, e.g. solvent based coatings. Specifically, powder coatings do not contain volatile organic solvents that evaporate during application or curing; omitting solvent results in considerable environmental and costs savings. For example, conditioned air from powder paint booths may be recycled rather than exhausted because it does not contain solvent vapor. Further, powder coating overspray is easily captured and recycled without the use of a water-wash system, eliminating environmentally difficult paint sludge from booth wash water.

Thermosetting coating powders are typically made by first blending or “dry mixing” the resin(s) and curing agent(s) with other dry ingredients, such as colorants, catalysts, flow control additives, fillers, or UV stabilizers in a batch mixer, also called a pre-mix hopper. This “pre-mix” batch is then fed to and melt compounded in a single- or twin-screw extruder body. In the extruder body, the resin melts, the ingredients are compacted, and the constituents are completely dispersed in the molten resin. A typical extruder body will have heat applied to the extruder body along the entire length thereof (except perhaps at the intake spot) to maintain the materials at an elevated temperature and facilitate the melt mixing process. The temperature applied along the length of the extruder is typically selected above the melt temperature of the resin but below the temperature that would cause significant crosslinking to occur. It is desired that minimal reaction occur between the resin(s) and curing agent(s) in the extruder. As the melt mix exits the extruder body, “extrudate” is cooled rapidly on a cooled drum and then passed to a cooled belt. The cooled extrudate is broken into granules. The friable granules are then ground in a hammer mill, or the like, to a fine particle size that may be further processed, such as by being screened in a classifier, before packaging.

The conventional powder-forming process can result in significant wasted product if the formulation is not precise. For example, if the extrudate is slightly off color as it exits the extruder body, as measured by an appropriate sensor (e.g. an electrical resistance sensor, or optical measurement sensor), then the amount of pigment added to the pre-mix hopper will be adjusted accordingly in the next batch; this is known as “batch control”. Adjustment cannot be made until the next batch. The product loss is effectively equal to the entire load of the material in the pre-mix hopper. Additional waste can be generated if pigment and/or other hard to incorporate components of the powder do not adequately blend to form a homogeneous material. Further, the color changes and/or formulation changes from one batch to the next require extensive and time-consuming cleaning of the pre-mix hopper and the extruder body. This cleaning time is particularly relevant when generating small batches of pigmented powder coatings. Therefore, there remains a need for an extrusion method of producing pigmented powder coating compositions that disperses hard to incorporate additives, such as pigments, uniformly throughout the extrudate without detrimentally affecting the extrudate and/or which allows for dynamic control and more efficient clean up between runs. There is also a need for such a method in which the addition of hard to incorporate additives is facilitated.

### SUMMARY OF THE INVENTION

The present invention provides an extruder system for manufacturing thermosetting powder coating compositions that maintains adequate dispersion of ingredients within the extrudate and includes an additive injection system with dynamic control; the present extruder system also allows rapid change out between runs of different colors and/or formulations. The present process for manufacturing powder coating compositions decreases product loss due to color control by using an additive pigment injector system.

### BRIEF DESCRIPTION OF THE DRAWING

FIG. 1 is a schematic view of an extruder according to an embodiment of the present invention.

### DETAILED DESCRIPTION OF THE INVENTION

The present invention is directed to an extruder comprising one or more rotating screws, and a plurality of adjacent segments surrounding the rotating screw(s). Optionally, a pre-mix hopper can be located upstream of the screws. Each segment includes a cooling system for cooling material in the segment, and a heating system for heating material in the segment, wherein the cooling systems and the heating systems of each segment can be selectively, independently operated. One segment has a main inlet for receiving material such as from the pre-mix hopper, and a final segment has an outlet for discharging material from the extruder. The extruder of the present invention further comprises an additive injector adapted to inject additives into one or more segments at one or more additive injection positions between the main inlet and the outlet.

The additive injector includes a low pressure vessel, and a flow regulator between the pressure vessel and the intermediate injection position. The injector further includes a source of pressurization, such as air, coupled to the pressure vessel for pressurizing the low pressure vessel. The injector further includes a pressure regulator for maintaining the pressure in the pressure vessel less than a set amount, such as about 100 PSI. The injector will include an injector outlet, or injection port, downstream of the flow regulator.

A process for manufacturing thermosetting powder coating composition according to the present invention comprises feeding base material into an extruder from an initial position, injecting one or more additives to the base material after the base material enters the extruder and before it exits the extruder, and passing the combined base material and additive(s) through at least a portion of the extruder to form a thermosetting powder coating composition. The injection step utilizes a low pressure vessel, a source of pressurization coupled to the pressure vessel, a mechanism for maintaining the pressure in the pressure vessel at a predetermined level, a flow regulator, and an injector outlet downstream of the flow regulator. The method may further include monitoring the extrudate at the extruder outlet to measure one or more desired characteristics of the coating composition and dynamically control the low pressure additive injector. The base material may be fed to the extruder, for example, from a pre-mix hopper through a main inlet. “Initial position” refers to the point at which base material is introduced to the extruder.

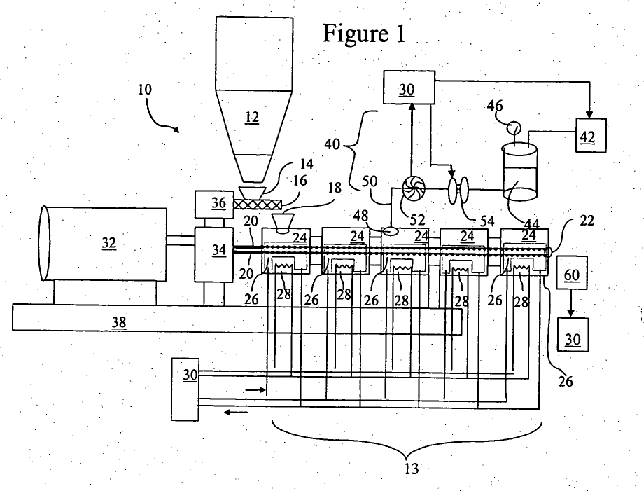

FIG. 1 is a schematic view of an extruder 10 for use in an extrusion process for manufacturing thermosetting powder coating compositions that provides dynamic control with a low pressure additive injector as described below. The extruder 10 includes a pre-mix hopper 12 for holding and introducing the base material and an extruder body 13. “Base material” refers to one or more of the components that, form the powder coating including, for example, resin(s), curing agent(s), catalyst(s), flow control additives, fillers, and/or UV stabilizers, and the like. Base material can include one or more “hard to incorporate additives” according to the present invention, but at least one hard to incorporate additive will not be added to the extruder as a base material. “Hard to incorporate additives” will be understood by those skilled in the art as additives that are not readily dispersed during the extrusion process, including pigments, flow additives, and components having a melting point higher than the melting point of the resin or average melting point of the resins, used in the base material. According to the present methods, at least one hard to incorporate additive(s) is added to the base material after the base material enters the extrudate from the initial position, and prior to the extrudate exiting the extruder body. The hard to incorporate additive(s) may be dispersed in a liquid diluent or in an aqueous dispersion, or may be in solid form. The combined base material and hard to incorporate additive(s) are passed and mixed through at least a portion of the extruder body to form a thermosetting powder coating composition. In one embodiment, the pre-mix hopper 12 feeds the base material through an exit or funnel 14 that leads to a mechanical feeder 16, such as a feed screw. The feeder 16 leads to a main inlet 18 of the extruder body 13. The extruder body 13 further includes a pair of feed screws 20 extending along the length of the extruder body 13 from the main inlet 18 to a main outlet 22 of the extruder body 13. The “length of the extruder body” 13 is measured from the main inlet 18 to the main outlet 22 along the feed screws 20.

Surrounding the screws 20 are a plurality of adjacent barrels or segments 24. FIG. 1 illustrates five (5) such segments, but any number of segments 24 may be provided as desired. Further, the individual segments 24 may be constructed of varying lengths. The five segments 24 shown in FIG. 1 are intended to merely illustrate the broad concepts of the extruder 10 of the present invention and not be restrictive thereof. Each segment 24 includes an independent fluid jacket 26 surrounding an internal mixing chamber and a heating coil 28 adjacent the internal mixing chamber. The fluid jacket 26 is generally utilized for cooling the material in the mixing chamber through the use of a cooling fluid (e.g. water). The fluid jackets 26 and the heating coils 28 of each segment 24 are independently controlled through a central controller 30. With independent control of the heating and cooling of each segment 24 by the central controller 30, the segments 24 form separate “zones” or “portions” along the length of the extruder body 13. FIG. 1 illustrates “three” controllers 30, however, these are the same element which is repeated on the figure to avoid having overlapping confusing lines to the controller 30.

The extruder 10 further includes a low pressure additive injector 40 for injecting additives, such as the hard to incorporate additives discussed above, particularly pigments, into the base material downstream of the exit or funnel 14 of the pre-mix hopper 12 before the main outlet 22 of the extruder body 13. The injector 40 includes a pressure source 42, such as an air pressure source, coupled to a low pressure vessel 44, which holds the additives. A pressure gauge/regulator 46 with pressure bypass (not shown) may be coupled to the pressure vessel 44 to provide a mechanism for maintaining low pressure in the pressure vessel 44 at a predetermined value, such as less than about 100 PSI. The pressure vessel 44 is coupled to an injection outlet or injection port 48 on the extruder body 13 through a feed line 50. The feed line 50 may include a flow meter 52 and control valve structure 54 forming a flow regulator structure. The pressure source 42 and control valve 54 may be controlled by the central controller 30 as will be discussed. Injection port 48 may be positioned at any point along the length of the extruder, such that the base material and hard to incorporate additive(s) will pass through at least a portion of the extruder body together to effect sufficient mixing.

The extruder 10 further includes a monitoror sensor 60 at the main outlet 22 of the extruder body 13. The monitor 60 and the flow meter 52 are coupled to the controller 30 to provide feedback on a relevant quality (e.g. color) and additive flow rate for dynamic control thereof. For example the electrical resistance of the extrudate may be indicative of a characteristic of the extrudate (e.g. color) and the monitor 60 will provide a real time feedback of this characteristic during processing of a batch. If the measured parameter is out of predetermined set points for the parameter, the controller 30 can dynamically adjust (i.e. during the processing of the batch) the flow rate (which is measured by the flow meter 52) through control of the control valve structure 54. The monitor 60 can then be used to check how the dynamic adjustment corrected the measured parameter by rechecking the extrudate after a time delay sufficient for the extrudate exiting the outlet 22 to have received the adjusted flow rate of the hard to incorporate additive(s). For example, a given color for a batch will have a predetermined flow rate of the desired pigment as a starting point. This predetermined starting flow rate will simply be based upon the calculated dispersion of pigment in the projected extrudate and the known flow rate of the extruder. If the color of the extrudate is incorrect as determined by the monitor 60, then the predetermined flow rate of pigment is also incorrect; the monitor 60 will measure the relevant parameter (e.g. electrical resistance) of the initial extrudate, the controller 30 will calculate an appropriate adjustment for the flow rate and dynamically change the flow rate. Thus, while the leading portion of the extrudate of a given batch is lost due to incorrect pigment addition, the remainder of the batch should have the proper color. Because the color can be constantly monitored, it can be adjusted as needed. Additional monitors 60 can be added to check any desired parameter as may be known in the art.

The process as described above may be repeated for separate thermosetting powder coatings having distinct hard to incorporate additives, e.g. distinct pigments or amount of pigments, wherein the separate thermosetting powder coatings utilize a common base material in the pre-mix hopper of the extruder. As will be appreciated by those skilled in the art, the cleaning of the pre-mix hopper and the extruder are very time intensive. Use of the same base material for several batches eliminates the need to clean the pre-mix hopper between batches. It is only the extruder body 13 and the additive injector 40 that needs to be cleaned between runs of distinct characteristics. Thus, while the present invention can be used for any batch size, it provides a significant time savings when manufacturing small batches of pigmented powder coatings. “Small batch” or “small batches” refers to a batch of 1000 pounds or less.

As noted above, the base material may travel through a portion of the extruder body 13 before the addition of the hard to incorporate additive(s), or the hard to incorporate additive(s) may be added between the exit 14 of the pre-mix hopper 12 of the extruder 10 and the beginning or main inlet 18 of a main extruder body 13 of the extruder 10. The hard to incorporate additive(s), particularly pigment(s), may be added in solid or liquid form. “Liquid form” includes but is not limited to the hard to incorporate additive(s) being contained in an aqueous dispersion or liquid diluent, and includes pigment paste(s). “Solid form” includes but is not limited to dried liquid dispersions, dried pigment paste(s) or standard dry pigments. In using pigment(s) in liquid form in the methods according to the present invention, a 15 percent reduction or more in pigment loading was found to provide equal color development as compared to the addition of pigment(s) in the dry mixing step as conventionally practiced. Moreover, the method of the present invention allows for reduced pigment loadings with superior color development and dispersion. Tinting and adjusting may also be controlled at the injection port in the method of the present invention. The base material may comprise at least one resinous binder having reactive functional groups and at least one crosslinking agent having functional groups reactive with the reactive functional groups on the resinous binder, such as wherein the resinous binder is a polymer selected from at least one of acrylics, polyesters, polyurethanes, and polyepoxides. Selection of appropriate base materials and hard to incorporate additives is well within the skill of one practicing in the art.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to oligomers and both homopolymers and copolymers; the prefix “poly” refers to two or more.

It will be readily apparent to those of ordinary skill in the art that various changes may be made to the present invention without departing from the spirit and scope thereof. The described embodiment is intended to be illustrative of the present invention and not restrictive thereof. The scope of the present invention is intended to be defined by the appended claims and equivalents thereto.

1. A powder coating composition extruder comprising:
one or more rotating screws;
a plurality of adjacent segments surrounding the rotating screw(s), each of the segments including a cooling system for cooling material in the segment, and a heating system for heating material in the segment, wherein the cooling system and the heating system of each of the segments can be selectively, independently operated, one of the segments having an inlet for receiving material into the extruder and one of the segments having an outlet for discharging material from the extruder; and
an additive injector for injecting one or more hard to incorporate additives into at least one segment at an injection position at the inlet or between the inlet and the outlet.

2. The extruder of claim 1, wherein the injector includes a pressure vessel, and a flow regulator between the pressure vessel and the injection position.

3. The extruder of claim 2, further including a source of pressurization coupled to the pressure vessel for pressurizing the pressure vessel.

4. The extruder of claim 3, further including a mechanism for maintaining the pressure in the pressure vessel less than about 100 PSI.

5. The extruder of claim 3, wherein each cooling system includes a cooling fluid inlet and outlet in each segment.

6. The extruder of claim 3, further including a pre-mix hopper and a mechanical feeder extending from an exit of the pre-mix hopper to the inlet of the extruder.

7. Allow pressure liquid additive injector for an extruder comprising:
a low pressure vessel;
a source of pressurization coupled to the pressure vessel;
a mechanism for maintaining the pressure in the pressure vessel less than about 100 PSI;
a flow regulator coupled to the pressure vessel; and
an injector outlet downstream of the flow regulator.

8. A powder coating composition extruder system with dynamic additive control comprising:
a pre-mix hopper adapted to hold a base material;
one or more rotating screws;
a plurality of adjacent segments surrounding the rotating screw(s), each of the segments including a fluid cooling system for cooling material in the segment, and a heating system for heating material in the segment, wherein the cooling system and the heating system of each of the segments can be selectively, independently operated, a first segment having a main inlet for receiving material from the pre-mix hopper and a final segment having an outlet for discharging material from the extruder;
a low pressure additive injector for injecting one or more liquid additive(s) into one or more chambers at a position at the main inlet or between the main inlet and the outlet, wherein the additive injector includes a low pressure vessel, a source of pressurization coupled to the pressure vessel, a mechanism for maintaining the pressure in the pressure vessel less than about 100 PSI, a flow regulator coupled to the pressure vessel, and an injector outlet downstream of the flow regulator; and
a monitor adjacent the outlet monitoring the characteristics of the coating composition and coupled to a controller for the additive injector.

9. The extruder system of claim 8, wherein each cooling system includes a cooling fluid inlet and outlet in each segment, and each heating system includes a heating element.

10. The extruder system of claim 8, further including a mechanical feeder extending from an exit of the pre-mix hopper to the main inlet.

11. The extruder system of claim 10, including a single motor driving the rotating screws and the mechanical feeder.

12. The extruder system of claim 8, wherein the position at which injection occurs is spaced along the extruder system at least one segment from the main inlet.
